(19) United States
(12) Patent Application Publication
(10) Pub. No.: US 2007/0007755 A1
(43) Pub. Date: Jan. 11, 2007

(54) Airbag pre-fold technique

(75) Inventors: Barney J. Bauer, Rochester, MI (US); Jerome Bosch, Clinton Township, MI (US); Amy L. Klinkenberger, Highland, MI (US)

Correspondence Address: FOLEY AND LARDNER LLP;SUITE 500, 3000 K STREET NW, WASHINGTON, DC, 20007, US

(73) Assignee: TAKATA RESTRAINT SYSTEMS, INC.

(21) Appl. No.: 11/175,365

(22) Filed: Jul. 7, 2005

(51) Int. Cl. B60R 21/233; B60R 21/237

(52) U.S. Cl. 280/729; 280/743.1

(57) ABSTRACT

A method of folding an airbag includes pre-folding an airbag in a generally geometric pattern and crush folding the airbag. The airbag is positioned flat on a first side with a first lobe lying over a second lobe. The lower corners of the lobes are tucked internally into their respective lobes or sides. The airbag is then folded twice to form a general Z shape along the side of the airbag. The airbag is then crush folded.

### BACKGROUND

The present invention relates generally to the field of airbag devices. More specifically, this invention relates to airbag devices that include a pre-fold prior to a crush fold.

Conventional airbags are used to protect passengers during an automobile collision. However, many different types of seats and child safety seats can be used, which affect how the airbag interacts with an occupant. For example, in a rear facing child safety seat having a relatively high seat back, a deploying airbag could catch the seat back and deploy downward between the seat back and an instrument panel. In a rear facing child safety seat with a lower seat back, a deploying airbag could deploy up and over the seat. Such conventional airbags do not offer additional control over the way in which the deploying airbag will interact with different seat designs.

### SUMMARY

One embodiment of the invention relates to an airbag module. The airbag module comprises a split cushion airbag with first and second lobes. The airbag is folded so that the first lobe is tucked internally into a first side of the airbag and the second lobe is tucked internally into a second side of the airbag, and the tucked lobes are crush folded.

Another embodiment of the invention relates to a method of folding an airbag. The method comprises laying an airbag flat on a first side with a first lobe laying over a second lobe, tucking a first lower corner into the first lobe, tucking a second lower corner into the second lobe, folding the airbag to form a first fold, folding the airbag to form a second fold, and crush folding the airbag.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a perspective view of an airbag held vertically prior to a Z-type pre-fold according to one embodiment of the present invention.

FIG. 2 is a view of the airbag laying flat on one side with two lobes, one on top of the other, according to the airbag shown in FIG. 1.

FIG. 3 is a view of the airbag shown in FIG. 1 with each lobe tucked into each lobe side.

FIG. 4 is a view of the airbag shown in FIG. 1 with the airbag flipped open such that the lobes lay on either side of a cushion centerline.

FIG. 5 is a view of the airbag shown in FIG. 1 with a first Z fold.

FIG. 6 is a view of the airbag shown in FIG. 1 with a second Z fold.

FIG. 7 is a view of the airbag shown in FIG. 1 with the airbag positioned in a crush machine after the pre-fold.

FIG. 8 is a view of the airbag shown in FIG. 1 after the completed pre-fold and crush fold operation.

FIG. 9 is a view of an airbag held vertically prior to a tuck and roll type pre-fold according to another embodiment of the present invention.

FIG. 10 is a view of the airbag laying flat on one side with two lobes, one on top of the other, according to the airbag shown in FIG. 9.

FIG. 11 is a view of the airbag shown in FIG. 9 with each lobe tucked into each lobe side.

FIG. 12 is a view of the airbag shown in FIG. 9 with the airbag flipped open such that the lobes lay on either side of a cushion centerline.

FIG. 13 is a view of the airbag shown in FIG. 9 at the beginning of a first roll fold.

FIG. 14 is a view of the airbag shown in FIG. 9 at the completion of the first roll fold.

FIG. 15 is a view of the airbag shown in FIG. 9 with a second roll fold.

### DETAILED DESCRIPTION

Hereinafter, embodiments of the present invention will be described with reference to the attached drawings.

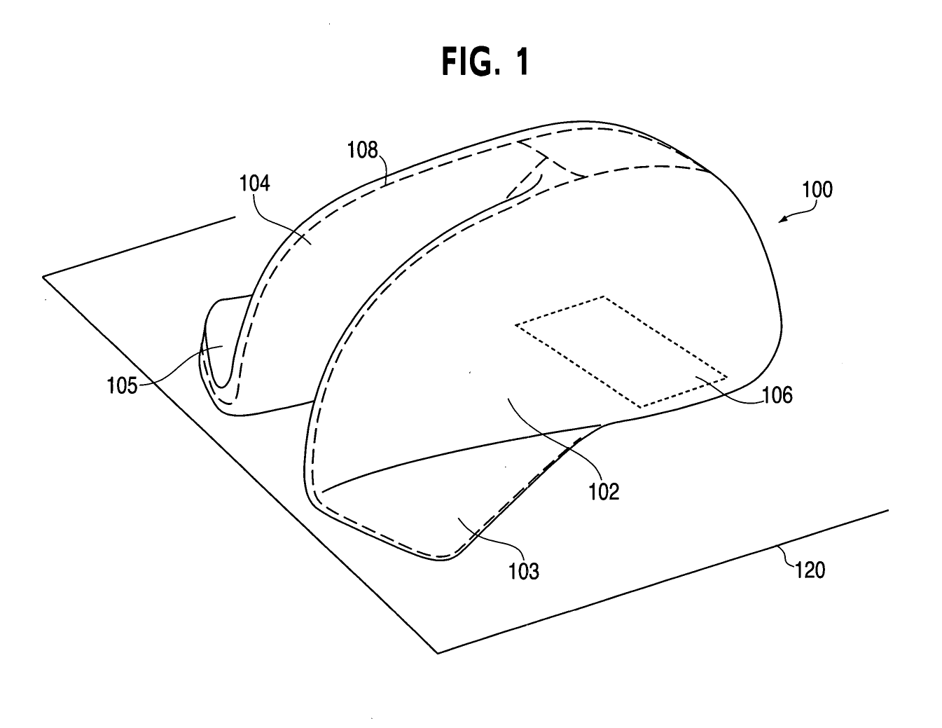

FIGS. 1-6 show a first embodiment of an airbag 100 of the present invention. The airbag 100 can be a split-cushion (dual lobe or NCPM) top-mount airbag. The airbag 100 includes a pre-fold prior to a crush fold. The pre-fold is a predetermined, geometric type fold, which influences the way in which the airbag 100 interacts with an occupant, a car seat, or a rear facing child safety seat. The pre-fold can, according to an embodiment of the invention, force the airbag 100 to “walk” up and over a seat back of a rear facing child safety seat if the pre-fold is positioned in the upper or front side of the airbag 100. If the pre-fold is positioned in a lower or rear side of the airbag 100, the airbag 100 will deploy downward between the back of the rear facing infant child seat and the instrument panel.

The airbag 100 could also be mounted in a door, in a steering wheel, in a headliner of the vehicle, along the side roofline, or any other suitable location for protecting a vehicle occupant. The airbag 100 can be inflated by a gas generator 101, such as shown in FIG. 1.

The airbag 100 comprises panels, which are sewn together at a seam 108, to form the inflatable cushion. The airbag 100 includes first 102 and second 104 sides. The first side 102 includes a first lobe 103 and the second side 104 includes a second lobe 105. The airbag 100 can also include a diffuser, which would be located at the underside of the airbag 100 as shown in FIG. 1 at 106. Each lobe 103, 105 is an extension of its respective side 102, 104, which extends away from the main portion of the airbag 100.

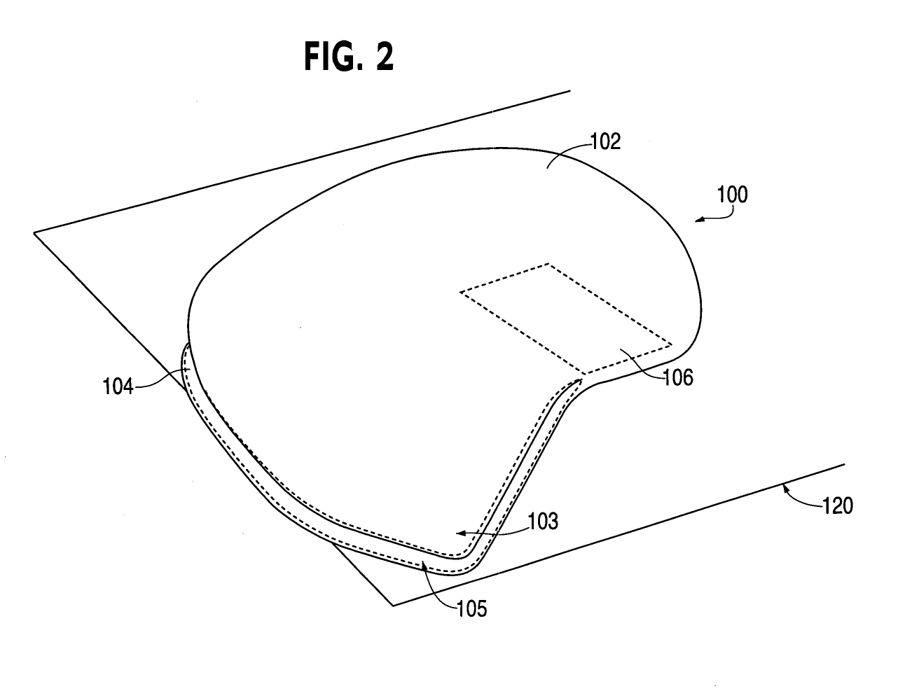

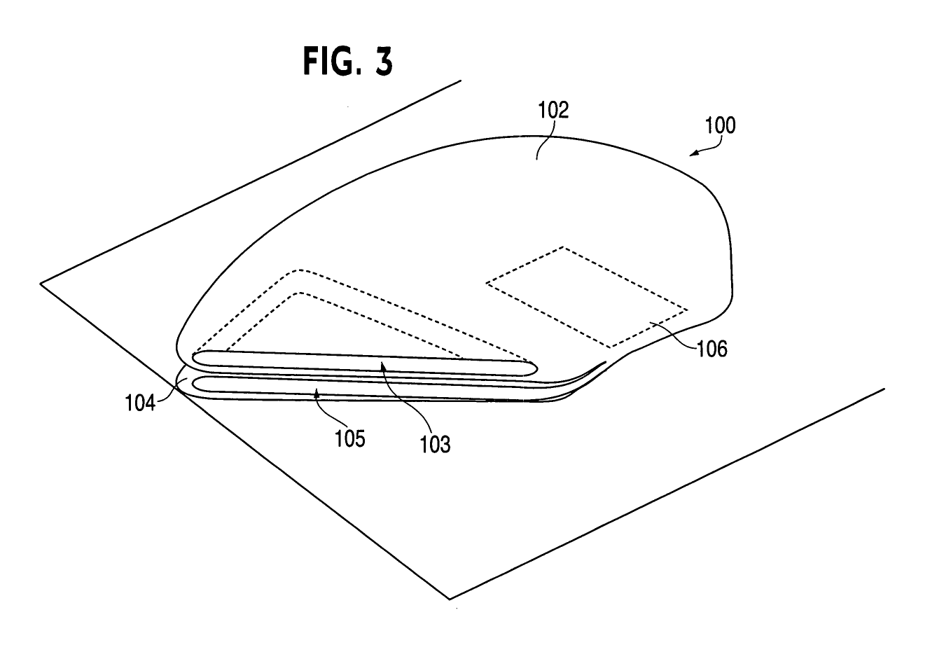

To pre-fold the airbag 100, the airbag 100 is positioned on one side on a folding table 120 such that the airbag 100 lays flat, as shown in FIG. 2. The first side 102 and first lobe 103 lay on top of the second side 104 and second lobe 105. A bottom section of each lobe 103, 105 is then tucked into itself. As shown in FIG. 3, a lower or bottom section of the first lobe 103 is tucked internally into the first side 102 at the first lobe 103, as indicated by the dashed lines. This creates a generally triangular shaped section tucked into the first side 102. This process is repeated for the second side 104 and second lobe 105. The tucked lobes 103, 105 can be clipped together, temporarily, by a clip or other suitable fastener.

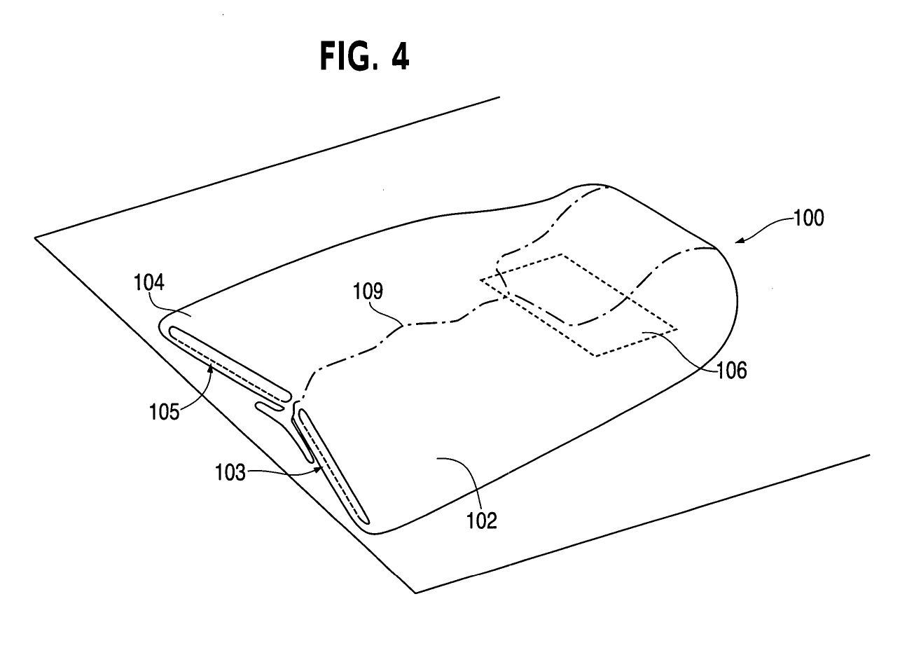

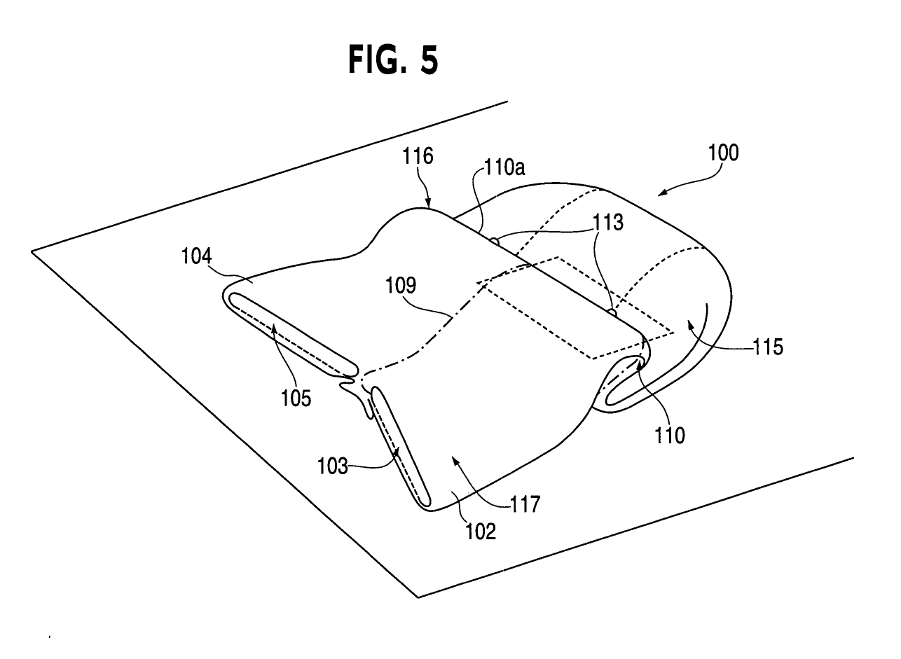

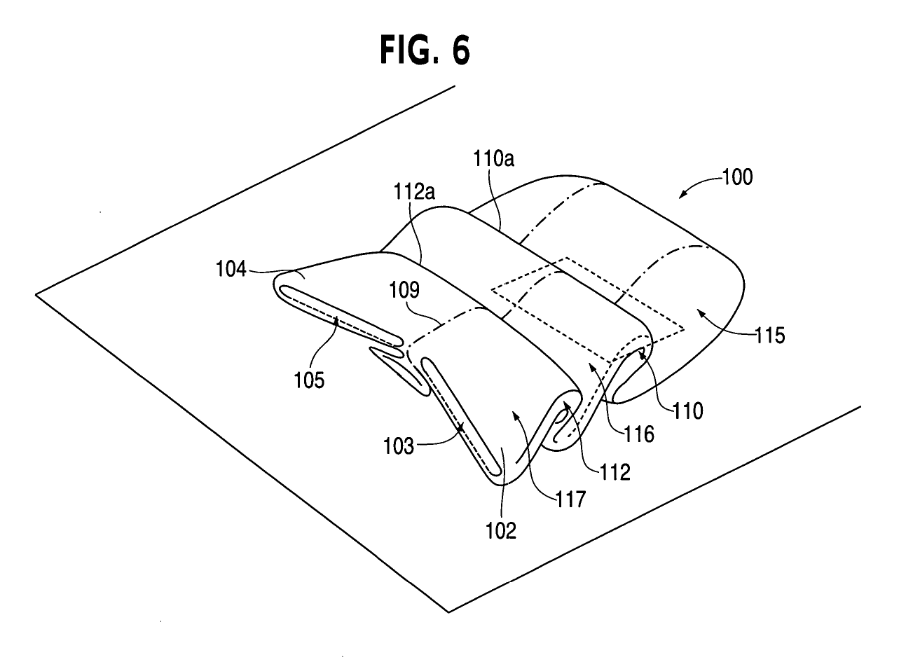

The airbag 100 is next opened up such that the each lobe 103, 105 lay on either side of a centerline 109 of the airbag 100. The lobes 103, 105 are still tucked into their respective sides 102, 104, as shown in FIG. 4. A first Z fold 110, shown in FIG. 5, is now added to the airbag 100. A section, generally along the middle 116 of the centerline 109, is gathered up to form a loop shape in the airbag 100. This loop is then positioned on the airbag 100 to overlap an upper section 115 of the airbag 100. The first fold 110 includes a first fold line 110a that extends between two center points 113 (imaginary or marked on the surface of the airbag 100 as guides) of the airbag 100 and the second fold 112 includes a second fold line 112a positioned between the first fold line 110a and the first and second lower corners or lobes 103, 105. The second fold 112 at least partially overlaps the first fold 110. FIG. 6 shows a second Z fold 112 added to the airbag 100. A lower section 117 of the airbag 100 is gathered to form a loop or roll. This loop or roll then overlaps a portion of the airbag 100 at the first Z fold 110. These first 110 and second 112 Z folds form a generally Z shape when viewed from the side, as can be seen in FIG. 6. This Z fold is a pre-fold for the airbag 100.

The airbag 100 could also include a template or reference marks to indicate the exact location and positions for the folds 110, 112. The folding table 120 could also, according to another embodiment, include the template or reference marks.

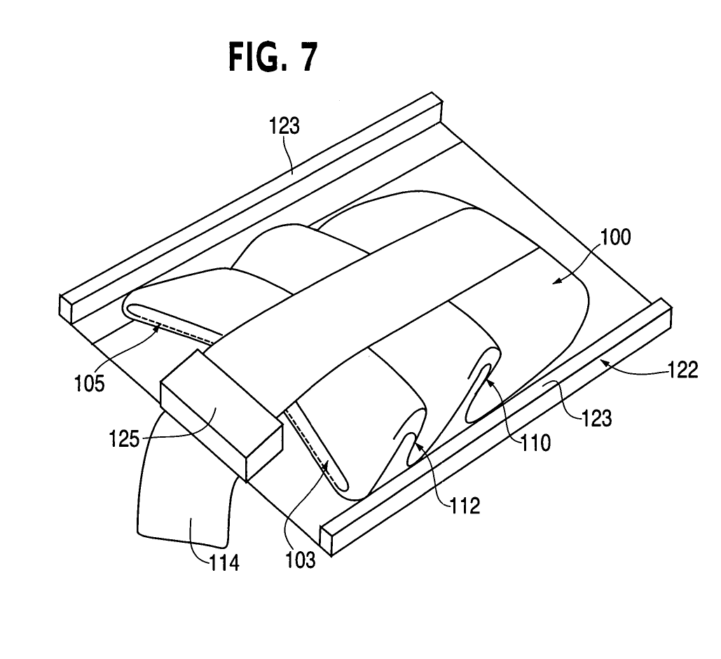

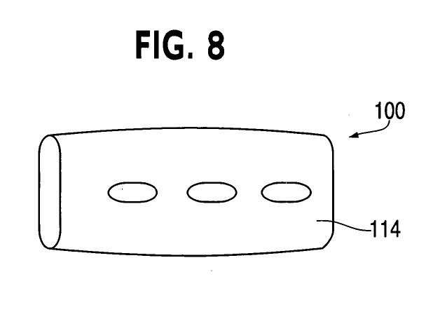

To complete the folding process for the airbag 100, the pre-folded airbag 100 undergoes a crush fold in a crush machine 122. The airbag 100 is positioned between two side rails 123 of the crush machine 122, as shown in FIG. 7. A cover sheet 114 is positioned over the top of the airbag 100 and extends out of the crush machine 122. A push block 125 is positioned at an end of the airbag 100 adjacent the tucked lobes 103, 105 and on top of the cover sheet 114. The airbag 100 is laterally crushed by the side rails 123. The push block 125 then pushes up against the airbag 100 to further crush fold it. During this operation, a “push and pull” operation takes place. The push block 125 is pushed against the airbag 100 and the cover sheet 114 is pulled, to smooth it out. Finally, the crushed airbag 100 is removed from the crush machine 122 and wrapped with the cover sheet 114, as can be seen in FIG. 8.

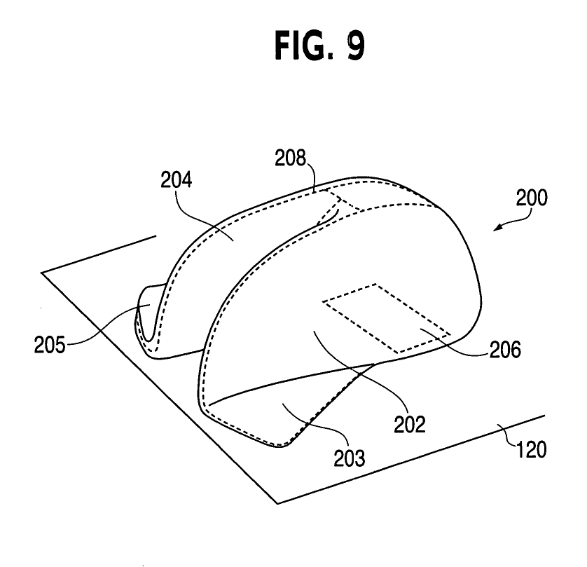

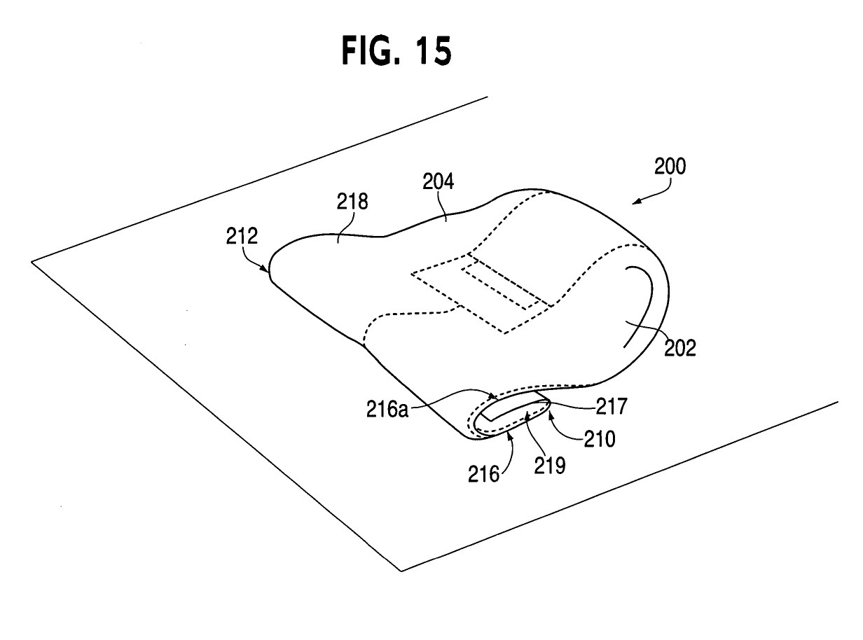

FIGS. 9-15 show another embodiment of the present invention. In this embodiment, an airbag 200 undergoes a tuck and roll type pre-fold. The airbag 200 can be a split-cushion (twin) top-mount airbag. The airbag 200 includes a tuck and roll type pre-fold prior to a crush fold.

The airbag 200 could also be a mounted in the middle of a dashboard, mounted in a door, in a steering wheel, in a headliner of the vehicle, along the side roofline, or any other suitable location for protecting a vehicle occupant.

The airbag 200 is similar to airbag 100 and comprises panels which are sewn together at a seam 208 to form the inflatable cushion. The airbag 200 includes first 202 and second 204 sides, a front or top side 218 and a rear side 219. The rear side 219 of the airbag 200 is the side initially adjacent of touching the folding table 120. The first side 202 includes a first lobe 203 and the second side 204 includes a second lobe 205. The airbag 200 can also include a diffuser 206a, which would be located at the underside of the airbag 200 as shown in FIG. 9 at 206. Each lobe 203, 205 is an extension of the irrespective sides 202, 204, which extends away from the main portion of the airbag 200.

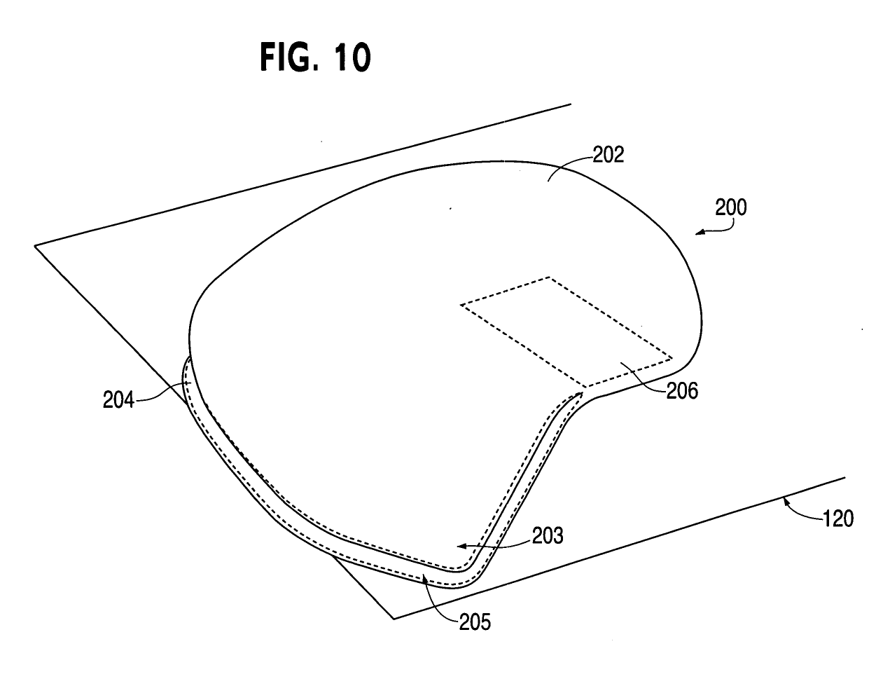

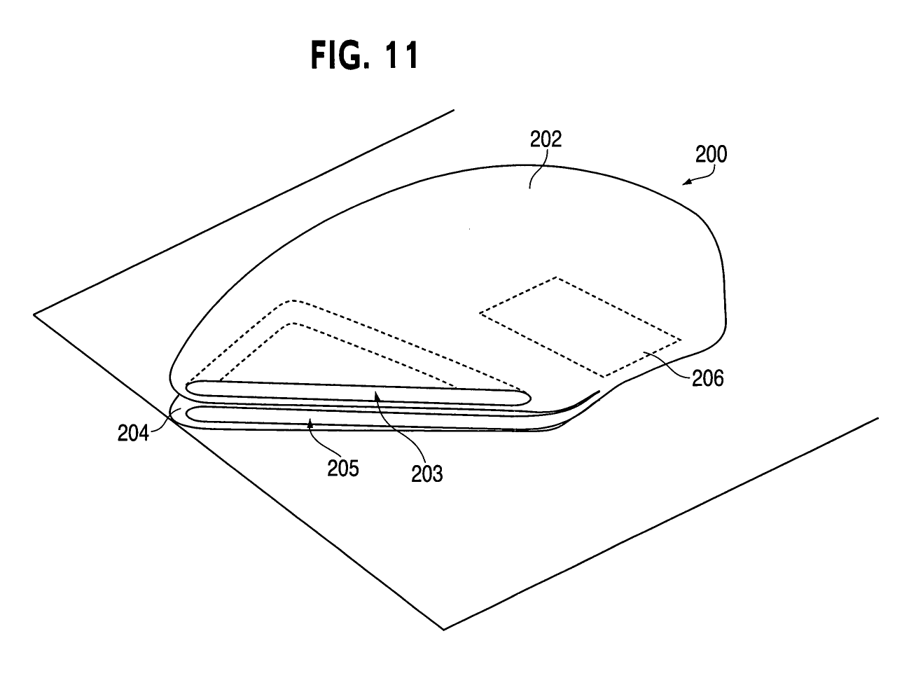

To pre-fold the airbag 200, the airbag 200 is positioned with the first side 202 on top of the second side 204, as shown in FIG. 10. The diffuser 206a can be installed in the airbag 200 at this point or at another time. As shown in FIG. 11 and similar to that shown in FIG. 3, the bottom of each lobe 203, 205 is folded or tucked internally into their respective sides 202, 204. The tucked in portions of the lobes 203, 205 form triangular sections inside of the airbag sides 202, 204.

The airbag 200 is then opened up, separating the first side 202 from the second side 204. The airbag 200 is arranged symmetrically on a folding table 120. The diffuser 206a can then placed into locator holes in the folding table 120. The airbag 200 is also flattened on the folding table 120.

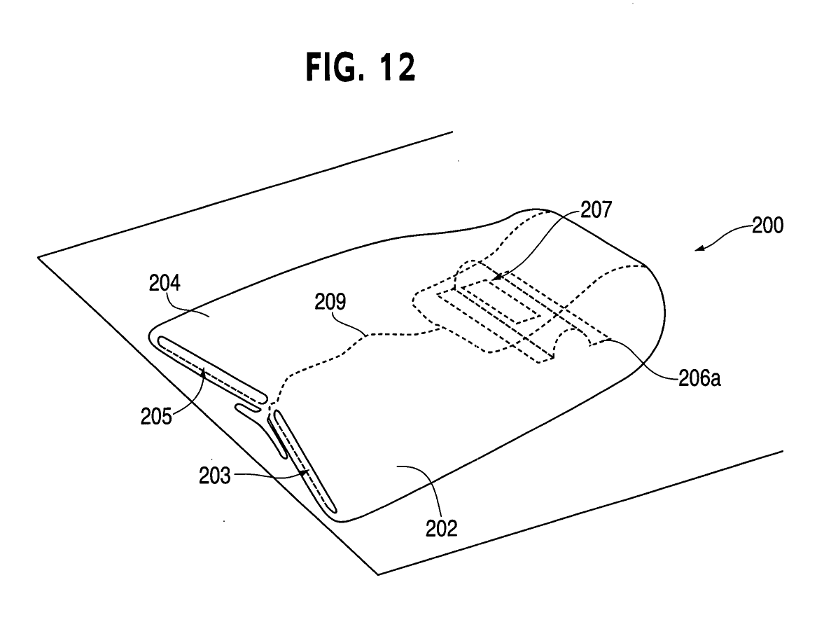

The airbag 200 can include target marks 207, which are shown in FIG. 12 and are positioned directly above the diffuser 206a. These target marks 207 can be held in position by hand or other mechanism. The target marks 207 can be the sewing line intersections on one side of a reinforcement of the airbag 200. In another embodiment, other airbag 200 construction features could be used to align the airbag 200 properly.

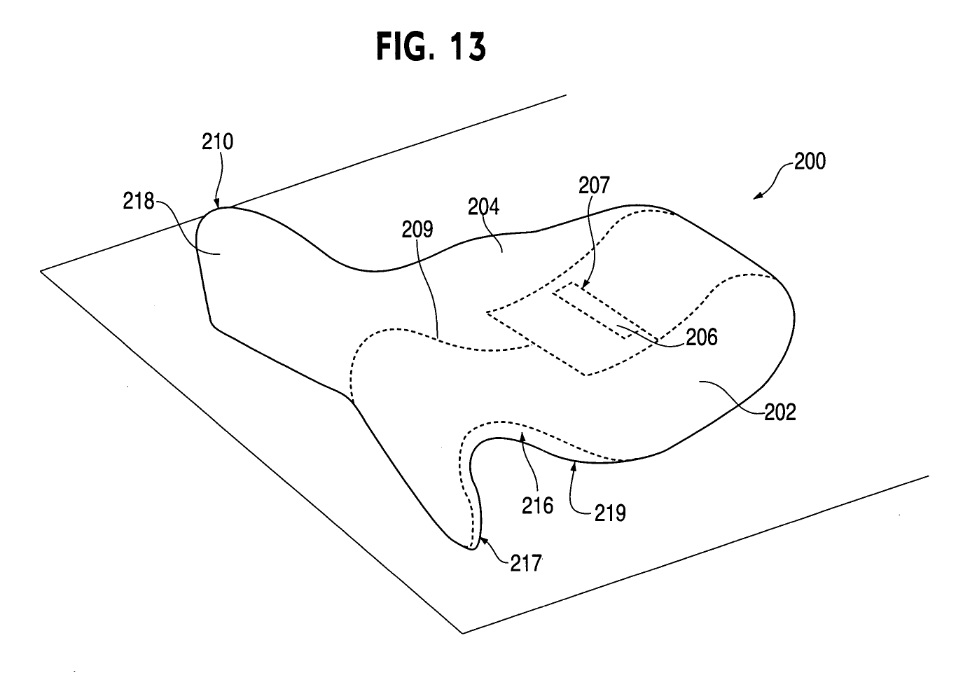

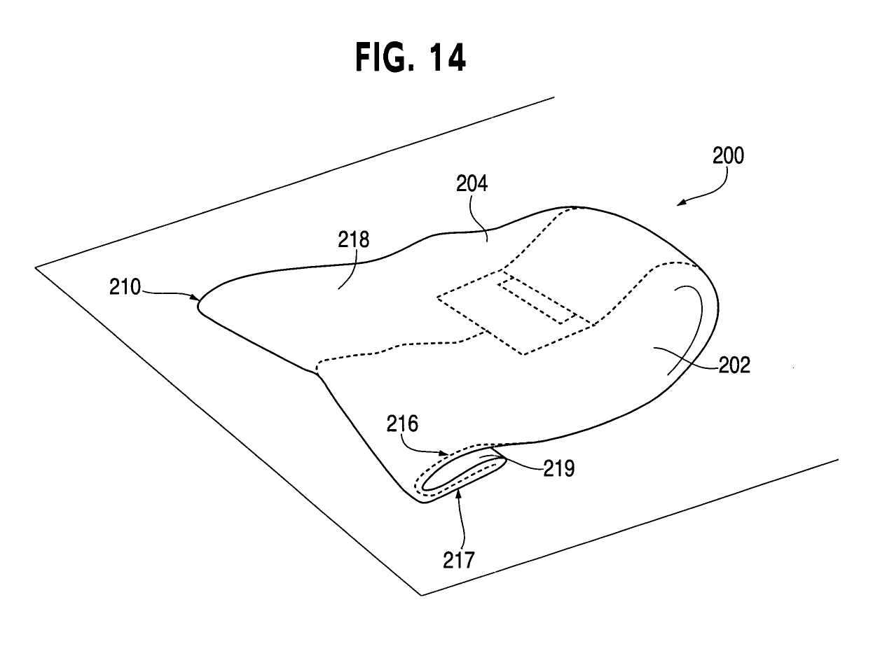

Next, as shown in FIGS. 13 and 14, a first fold 210 is positioned in the airbag 200. The first fold 210 includes folding the rear side 219 of the airbag 200 underneath the front side 218 such that that the rear side 219 of the lower section 217 is positioned adjacent the rear side 219 of another or middle portion 216 of the airbag 200. The former front side 218 of the first folded section (the lower section 217) is now positioned underneath the rear side 219 of the airbag 200 along the middle section 216.

A second fold 212 includes folding, by rolling, the lower section 217 such that the former front side 218 of the lower section 217 is now adjacent the rear side 218 of another portion (second middle section 216a) of the airbag 200.

To complete the folding process for the airbag 200, the pre-folded airbag 200 can undergo a crush fold in a crush machine 122 similar to that described above and shown in FIG. 7. The crush machine 122 includes side rails 123 and a push block to perform a crush folding similar to that described above.

It will be recognized that any combination of embodiments, or elements from various embodiments, may be used in another embodiment of the present invention. Further, additional steps or fold operations may be utilized during this pre-fold and/or crush.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. An airbag module, comprising:
a split cushion airbag with first and second lobes,
wherein the airbag is folded so that the first lobe is tucked internally into a first side of the airbag and the second lobe is tucked internally into a second side of the airbag, and the tucked lobes are crush folded.

2. The module of claim 1, wherein the airbag is a split cushion, top mounted airbag.

3. The module of claim 1, wherein the airbag further includes additional folds.

4. The module of claim 3, wherein the additional folds include first and second Z folds such that a middle section along a centerline of the airbag is overlapped onto an upper section and a lower section along a centerline of the airbag is overlapped onto a portion of the first Z fold, and wherein the first and second Z folds form a general Z shape along the side of the airbag.

5. The module of claim 3, wherein the airbag includes an upper, middle and lower sections, a front side and rear side, and wherein the additional folds include a first fold tucking the lower section of the airbag underneath the front side such that the rear side of the lower section is positioned adjacent the rear side of another portion of the airbag and a former front side of the lower section is now positioned underneath the rear side of the airbag.

6. The module of claim 5, wherein the additional folds further include a second fold further folding the lower section underneath the rear side of the airbag such that the former front side of the lower section is now adjacent the rear side of another portion of the airbag.

7. A method of folding an airbag, comprising:
laying an airbag flat on a first side with a first lobe lying over a second lobe;
tucking a first lower corner into the first lobe;
tucking a second lower corner into the second lobe;
folding the airbag to form a first fold;
folding the airbag to form a second fold; and
crush folding the airbag.

8. The method according to claim 7, further comprising opening the airbag up so first lobe separated from second lobe prior to tucking.

9. The method according to claim 7, further comprising temporarily clipping the first and second corners after tucking the keep the first and second corners in position.

10. The method according to claim 7, wherein the first fold includes a first fold line extends between two center points of the airbag and the second fold includes a second fold line between the first fold line and the first and second lower corners, and wherein the second fold at least partially overlaps the first fold.

11. The method according to claim 10, wherein the first and second folds form a general Z-shape in a side view of the airbag.

12. The method of claim 7, wherein the crush folding occurs after the first and second folds.

13. The method of claim 7, wherein the airbag includes a top, bottom, front side and rear side, and wherein the first fold includes folding the bottom of the airbag underneath the front side such that that the rear side of the bottom is positioned adjacent the rear side of another portion of the airbag, and a former front side of the first folded section is now positioned underneath the rear side of the airbag.

14. The method according to claim 13, wherein the second fold includes folding the bottom section underneath the rear side of the airbag such that the former front side of first folded section is now adjacent the rear side of another portion of the airbag.
